(19) United States
(12) Patent Application Publication
(10) Pub. No.: US 2008/0263035 A1
(43) Pub. Date: Oct. 23, 2008

(54) GROUPING BUSINESS PARTNERS IN E-BUSINESS TRANSACTION

(76) Inventors: James D. Episale, Binghamton, NY (US); Luella A. Korsky, Elmira, NY (US); Amy J. Snavely, Binghamton, NY (US)

Correspondence Address: HOFFMAN WARNICK LLC, 75 STATE ST, 14TH FLOOR, ALBANY, NY, 12207, US

(21) Appl. No.: 11/738,623

(22) Filed: Apr. 23, 2007

(51) Int. Cl. G06F 17/30

(52) U.S. Cl. 707/6; 707/E17.001

(57) ABSTRACT

A method, system and computer program product for conducting an electronic business are disclosed. An attribute of a business partner is used to identify the business partner. Business partners having the same attribute will be grouped as a business partner group. The business partner group will be used in conducting a business transaction.

### FIELD OF THE INVENTION

The present invention relates in general to an electronic business, and more particularly to grouping business partners in an electronic business transaction.

### BACKGROUND OF THE INVENTION

In a typical electronic business (e-business) transaction, a transaction initiator, e.g., a buyer, may need to access resources of multiple suppliers. Traditionally, the buyer may have to sort suppliers, collect necessary information of the suppliers, and/or obtain accesses to the supplier systems separately. These works may be very time-consuming, especially in the case that different suppliers are needed for different transactions. As a consequence, the full potential of e-business cannot be achieved.

Based on the above, there is a need in the art for a new solution to group business partners in an electronic business transaction.

### SUMMARY OF THE INVENTION

A first aspect of the invention is directed to a method for conducting an electronic business, the method comprising: identifying a business partner using an attribute of the business partner; assigning the business partner into a business partner group based on the attribute; and using the business partner group in conducting a business transaction.

A second aspect of the invention is directed to a system for conducting an electronic business, the system comprising: means for identifying a business partner using an attribute of the business partner; means for assigning the business partner into a business partner group based on the attribute; and means for providing a platform for using the business partner group in conducting a business transaction.

A third aspect of the invention is directed to a computer program product comprising: computer usable program code which, when executed by a computer system, is configured to enable the computer system to: identify a business partner using an attribute of the business partner; assign the business partner into a business partner group based on the attribute; and provide a platform for using the business partner group in conducting a business transaction.

A fourth aspect of the invention is directed to a method for deploying a system for conducting an electronic business, the method comprising: providing a computer infrastructure being operable to: identify a business partner using an attribute of the business partner; assign the business partner into a business partner group based on the attribute; and provide a platform for using the business partner group in conducting a business transaction.

Other aspects and features of the present invention, as defined solely by the claims, will become apparent to those ordinarily skilled in the art upon review of the following non-limited detailed description of the invention in conjunction with the accompanying figures.

### BRIEF DESCRIPTION OF THE DRAWINGS

The embodiments of this invention will be described in detail, with reference to the following figures, wherein like designations denote like elements, and wherein:

FIG. 1 shows a block diagram of an illustrative computer environment according to an embodiment of the invention.

FIG. 2 shows an embodiment of the operation of an e-business server according to the invention.

It is noted that the drawings of the invention are not to scale. The drawings are intended to depict only typical aspects of the invention, and therefore should not be considered as limiting the scope of the invention. In the drawings, like numbering represents like elements among the drawings.

### DETAILED DESCRIPTION OF THE INVENTION

The following detailed description of embodiments refers to the accompanying drawings, which illustrate specific embodiments of the invention. Other embodiments having different structures and operations do not depart from the scope of the present invention.

### 1. Computer Environment

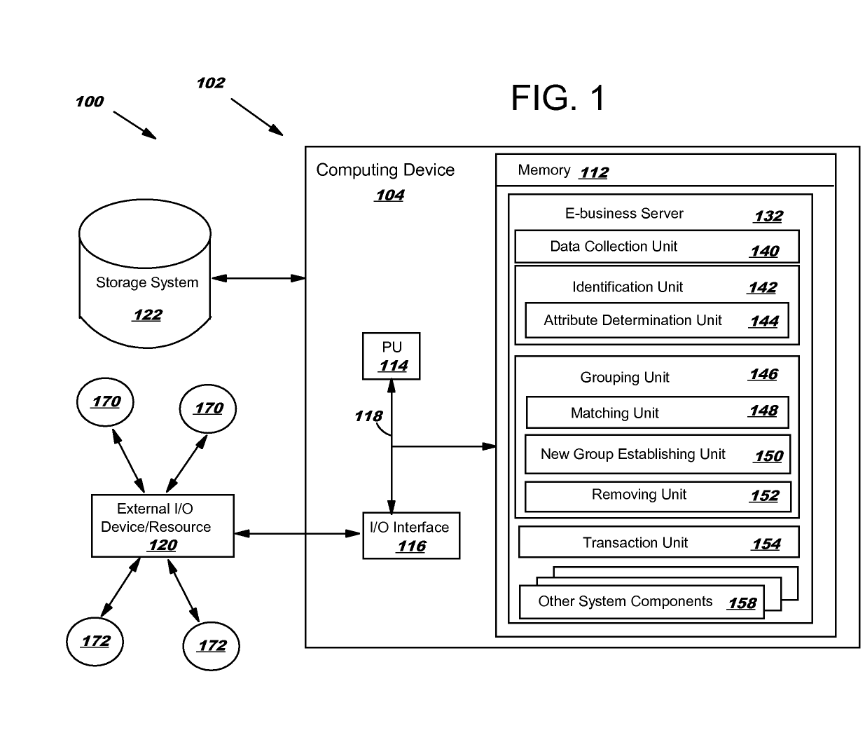

FIG. 1 shows an illustrative environment 100 for providing a platform to conduct e-business. To this extent, environment 100 includes a computer infrastructure 102 that can perform the various processes described herein for conducting an electronic business (e-business). In particular, computer infrastructure 102 is shown including a computing device 104 that comprises an e-business server 132, which enables computing device 104 to perform the process(es) described herein.

Computing device 104 is shown including a memory 112, a processing unit (PU) 114, an input/output (I/O) interface 116, and a bus 118. Further, computing device 104 is shown in communication with an external I/O device/resource 120 and a storage system 122. In general, PU 114 executes computer program code, such as e-business server 132, that is stored in memory 112 and/or storage system 122. While executing computer program code, PU 114 can read and/or write data to/from memory 112, storage system 122, and/or I/O interface 116. Bus 118 provides a communications link between each of the components in computing device 104. I/O interface 116 can comprise any device that enables a user to interact with computing device 104 or any device that enables computing device 104 to communicate with one or more other computing devices. External I/O device/resource 120 can be coupled to the system either directly or through I/O interface 116.

In any event, computing device 104 can comprise any general purpose computing article of manufacture capable of executing computer program code installed thereon. However, it is understood that computing device 104 and e-business server 132 are only representative of various possible equivalent computing devices that may perform the various processes of the disclosure. To this extent, in other embodiments, computing device 104 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively.

Similarly, computer infrastructure 102 is only illustrative of various types of computer infrastructures for implementing the invention. For example, in an embodiment, computer infrastructure 102 comprises two or more computing devices that communicate over any type of wired and/or wireless communications link, such as a network, a shared memory, or the like, to perform the various processes of the disclosure. When the communications link comprises a network, the network can comprise any combination of one or more types of networks (e.g., the Internet, a wide area network, a local area network, a virtual private network, etc.). Network adapters may also be coupled to the system to enable the data processing system to become coupled to other data processing systems or remote printers or storage devices through intervening private or public networks. Modems, cable modem and Ethernet cards are just a few of the currently available types of network adapters. Regardless, communications between the computing devices may utilize any combination of various types of transmission techniques.

E-business server 132 includes a data collection unit 140; an identification unit 142 including an attribute determination unit 144; a grouping unit 146 including a matching unit 148, a new group establishing unit 150 and a removing unit 152; a transaction unit 154; and other system components 158. Other system components 158 may include any now known or later developed parts of e-business server 132 not individually delineated herein, but understood by those skilled in the art. As should be appreciated, components of computer infrastructure 102 and e-business server 132 may be located at different physical locations or at the same physical location.

Inputs/outputs to computer infrastructure 102, e.g., through external I/O device/resource 120 and/or I/O interface 116, may include communications between e-business server 132 and an individual(s) 170 (two are shown) who conducts an e-business transaction through e-business server 132 (referred to as a user 170 for simplicity purposes) and between e-business server 132 and business partners 172 (two are shown) that user 170 potentially may do e-business transactions with. For example, a user 170 may contact e-business server 132 with the nature of an e-business transaction the user 170 plans to conduct through e-business server 132. E-business server 132 may select potential business partners 172 for the transaction and allow the user 170 to contact the selected business partners 172 simultaneously. The operation of e-business server 132 will be described herein in detail.

### 2. Operation Methodology

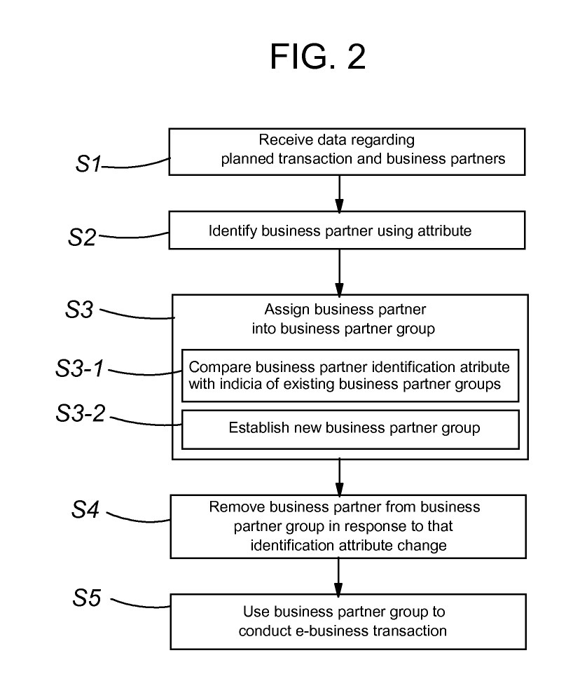

An embodiment of the operation of e-business server 132 is shown in the flow diagram of FIG. 2. Referring to FIGS. 1-2, in process S1, data collection unit 140 receives data regarding a planned e-business transaction. The information may be of any content and in any format mutually recognized between user 170 and e-business server 132. For example, user 170 may communicate to e-business server 132 a nature of the planned e-business transaction, one or more business partners 172 user 170 intends to work with, and/or an attribute of the business partners 172. Data collection unit 140 may also collect data regarding information of a business partner 172. Any information of a business partner 172 may be collected and all are included in the disclosure. For example, the information may include attributes of a business partner 172, contact information thereof, and/or specific requirements for user 170 to get access to the resources of business partner 172, etc.

In process S2, identification unit 142 identifies a business partner 172 using an attribute thereof. Such an attribute will be referred to herein as an “identification attribute” for illustrative purposes. Any attribute may be used to identify a business partner 172, and all are included. For example, the identification attribute may be a customer satisfaction level, a credit score, a business size, a business type, a transaction volume, a location, a transaction history with user 170, etc. According to an embodiment, the identification attribute is determined based on each specific e-business transaction. For different e-business transactions, identification unit 142 may identify business partners 172 using different attributes. In addition, multiple identification attributes may be used together to identify a business partner 172.

According to an embodiment, user 170 may select an identification attribute. For example, user 170 may instruct e-business server 132 to identify business partners 172 based on customer satisfaction levels thereof. Any method may be used for user 170 to communicate the selection of attribute to identification unit 142, and all are included in the invention. For example, user 170 may select an identification attribute from a list of attributes provided by e-business server 132 through a graphic user interface (GUI).

According to another embodiment, attribute determination unit 144 may select the identification attribute based on, e.g., a nature of the business transaction. For example, in the case user 170 plans a business transaction to purchase an automobile, attribute determination unit 144 may select business type of business partners 172 as the identification attribute.

In process S3, grouping unit 146 assigns a business partner 172 into a business partner group. A business partner group is formed based on identification attributes of business partners 172. That is, business partners 172 with identification attributes meeting a preset standard will be grouped together. The preset standard of identification attributes may be used as an indicium of the business partner group. As identification attributes may be selected specifically for a business transaction, the indicium of a business partner group and thus the grouping of business partners 172 may also be determined specifically for the business transaction. Any method of determining an indicium may be used, and all are included in the disclosure. As business partner 170 may be identified by multiple identification attributes, the indicium of a business partner group may also include standards with respect to multiple identification attributes.

According to an embodiment, process S3 may include two sub-processes. In sub-process S3-1, matching unit 148 compares the identification attribute of a business partner 172 with an indicium of an existing business partner group. In response to that the identification attribute matches the indicium, matching unit 148 assigns the business partner 170 into the business partner group.

In response to that the identification attribute of a business partner 172 does not match the indicium of any existing business partner group, in sub-process S3-2, new group establishing unit 150 establishes a new business partner group having an indicium determined based on the identification attribute of the business partner 172. The business partner 172 is included in the new business partner group. In addition, grouping unit 146 may assign other business partners 172 into the newly established business partner group based on the identification attributes thereof, i.e., whether the identification attributes match the indicium of the newly established business partner group.

In process S4, removing unit 152 removes a business partner 172 from a business partner group in response to a change in the identification attribute of the business partner 170. For example, if a business partner 172 is within a group of “high” customer satisfaction level, and updated information indicates that the customer satisfaction level of this business partner 172 has changed to “low”, removing unit 152 will remove this business partner 172 from the group.

In process S5, transaction unit 154 provides a platform for user 170 to use the business partner group to conduct the business transaction. Any use of the business partner group may be possible, and all are included in the disclosure. For example, transaction unit 154 may enable a user 170 to get accesses to the resources of all business partners 172 within the group. Transaction unit 154 may also enable user 170 to send messages, e.g., quoting prices, to all the business partners 172 within the group substantially simultaneously.

### 3. Conclusion

While shown and described herein as a method and system for conducting an electronic business, it is understood that the disclosure further provides various alternative embodiments. For example, in an embodiment, the invention provides a program product stored on a computer-readable medium, which when executed, enables a computer infrastructure to provide a system to conduct an electronic business. To this extent, the computer-readable medium includes program code, such as e-business server 132 (FIG. 1), which implements the process described herein. It is understood that the term “computer-readable medium” comprises one or more of any type of physical embodiment of the program code. In particular, the computer-readable medium can comprise program code embodied on one or more portable storage articles of manufacture (e.g., a compact disc, a magnetic disk, a tape, etc.), on one or more data storage portions of a computing device, such as memory 112 (FIG. 1) and/or storage system 122 (FIG. 1), and/or as a data signal traveling over a network (e.g., during a wired/wireless electronic distribution of the program product).

In another embodiment, the invention provides a method of generating a system for conducting an electronic business. In this case, a computer infrastructure, such as computer infrastructure 102 (FIG. 1), can be obtained (e.g., created, maintained, having been made available to, etc.) and one or more systems for performing the process described herein can be obtained (e.g., created, purchased, used, modified, etc.) and deployed to the computer infrastructure. To this extent, the deployment of each system can comprise one or more of: (1) installing program code on a computing device, such as computing infrastructure 102 (FIG. 1), from a computer-readable medium; (2) adding one or more computing devices to the computer infrastructure; and (3) incorporating and/or modifying one or more existing systems of the computer infrastructure to enable the computer infrastructure to perform the process steps of the invention.

In still another embodiment, the invention provides a business method that performs the process described herein on a subscription, advertising supported, and/or fee basis. That is, a service provider could offer to provide an environment to conduct an electronic business as described herein. In this case, the service provider can manage (e.g., create, maintain, support, etc.) a computer infrastructure, such as computer infrastructure 102 (FIG. 1), that performs the process described herein for one or more customers and communicates the results to the one or more customers. In return, the service provider can receive payment from the customer(s) under a subscription and/or fee agreement and/or the service provider can receive payment from the sale of advertising to one or more third parties.

As used herein, it is understood that the terms “program code” and “computer program code” are synonymous and mean any expression, in any language, code or notation, of a set of instructions that cause a computing device having an information processing capability to perform a particular function either directly or after any combination of the following: (a) conversion to another language, code or notation; (b) reproduction in a different material form; and/or (c) decompression. To this extent, program code can be embodied as one or more types of program products, such as an application/software program, component software/a library of functions, an operating system, a basic I/O system/driver for a particular computing and/or I/O device, and the like. Further, it is understood that the terms “component” and “system” are synonymous as used herein and represent any combination of hardware and/or software capable of performing some function(s).

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

What is claimed is:

1. A method for conducting an electronic business, the method comprising:
identifying a business partner using an attribute of the business partner;
assigning the business partner into a business partner group based on the attribute; and
using the business partner group in conducting a business transaction.

2. The method of claim 1, wherein the assigning includes comparing the attribute of the business partner with an indicium of an existing business partner group and assigning the business partner into the existing business partner group in the case that the attribute matches the indicium.

3. The method of claim 2, wherein in the case that the attribute does not match an indicium of any existing business partner group, the assigning includes establishing a business partner group that has an indicium determined based on the attribute.

4. The method of claim 3, further comprising assigning another business partner into the established business partner group based on an attribute of the another business partner.

5. The method of claim 1, wherein an individual conducting the business transaction selects the attribute of the business partner.

6. The method of claim 1, wherein a server used for the electronic business selects the attribute of the business partner.

7. The method of claim 1, further comprising removing the business partner from the business partnership group in the case that the attribute of the business partner changes.

8. A system for conducting an electronic business, the system comprising:
means for identifying a business partner using an attribute of the business partner;
means for assigning the business partner into a business partner group based on the attribute; and
means for providing a platform for using the business partner group in conducting a business transaction.

9. The system of claim 8, wherein the assigning means compares the attribute of the business partner with an indicium of an existing business partner group and assigns the business partner into the existing business partner group in the case that the attribute matches the indicium.

10. The system of claim 9, wherein in the case that the attribute does not match an indicium of any existing business partner group, the assigning means establishes a business partner group that has an indicium determined based on the attribute.

11. The system of claim 10, further comprising means for assigning another business partner into the established business partner group based on an attribute of the another business partner.

12. The system of claim 8, wherein the identifying means identifies the business partner using the attribute selected by an individual conducting the business transaction.

13. The system of claim 8, further comprising means for selecting the attribute of the business partner.

14. The system of claim 8, further comprising means for removing the business partner from the business partnership group in the case that the attribute of the business partner changes.

15. A computer program product comprising:
computer usable program code which, when executed by a computer system, is configured to enable the computer system to:
identify a business partner using an attribute of the business partner;
assign the business partner into a business partner group based on the attribute; and
provide a platform for using the business partner group in conducting a business transaction.

16. The program product of claim 15, wherein the program code is configured to enable the computer system to compare the attribute of the business partner with an indicium of an existing business partner group and to assign the business partner into the existing business partner group in the case that the attribute matches the indicium.

17. The program product of claim 16, wherein in the case that the attribute does not match an indicium of any existing business partner group, the program code is configured to enable the computer system to establish a business partner group that has an indicium determined based on the attribute.

18. The program product of claim 17, wherein the program code is further configured to enable the computer system to assign another business partner into the established business partner group based on an attribute of the another business partner.

19. The program product of claim 15, wherein the program code is configured to enable the computer system to receive an instruction from an individual conducting the business transaction regarding the attribute used to identify the business partner.

20. The program product of claim 15, wherein the program code is further configured to enable the computer system to select the attribute of the business partner.

21. The program product of claim 15, wherein the program code is further configured to enable the computer system to remove the business partner from the business partnership group in the case that the attribute of the business partner changes.

22. A method for deploying a system for conducting an electronic business, the method comprising:
providing a computer infrastructure being operable to:
identify a business partner using an attribute of the business partner;
assign the business partner into a business partner group based on the attribute; and
provide a platform for using the business partner group in conducting a business transaction.

23. The method of claim 22, wherein the computer infrastructure is operable to compare the attribute of the business partner with an indicium of an existing business partner group and to assign the business partner into the existing business partner group in the case that the attribute matches the indicium.

24. The method of claim 23, wherein in the case that the attribute does not match an indicium of any existing business partner group, the computer infrastructure is operable to establish a business partner group that has an indicium determined based on the attribute.

25. The method of claim 24, wherein the computer infrastructure is further operable to assign another business partner into the established business partner group based on an attribute of the another business partner.

26. The method of claim 22, wherein the computer infrastructure is operable to receive an instruction regarding the attribute used to identify the business partner from an individual conducting the business transaction.

27. The method of claim 22, wherein the computer infrastructure is operable to select the attribute of the business partner.

28. The method of claim 22, wherein the computer infrastructure is further operable to remove the business partner from the business partnership group in the case that the attribute of the business partner changes.
